(19) United States
(12) Patent Application Publication
(10) Pub. No.: US 2004/0078203 A1
(43) Pub. Date: Apr. 22, 2004

(54) Dictation card communication system

(76) Inventor: Eric J. Peter, Elm Grove, WI (US)

Correspondence Address: QUARLES & BRADY LLP, 411 E. WISCONSIN AVENUE, SUITE 2040, MILWAUKEE, WI, 53202-4497, US

(21) Appl. No.: 10/682,701

(22) Filed: Oct. 9, 2003

Related U.S. Application Data
(63) Continuation of application No. 09/443,821, filed on Nov. 19, 1999.
(60) Provisional application No. 60/109,278, filed on Nov. 20, 1998.

(51) Int. Cl. G10L 21/00

(52) U.S. Cl. 704/275

(57) ABSTRACT

A work flow and communication system, particularly suited for an office environment, uses small, low-cost digital memo cards to convey a spoken message from a speaker to an associate. The speaker selects one of the cards and activates its record function and then speaks a message relevant to a particular business matter to record the message on the card. The card is then coupled via the attachment member to an office object that is associated with the business matter subject of the message. The office object is conveyed to the associate who can then play back the recorded message on the dictation card.

### CROSS-REFERENCE TO RELATED APPLICATIONS

This application is a continuation of U.S. application Ser. No. 09/443,821, filed Nov. 19, 1999, which claims the benefit of U.S. provisional application Ser. No. 60/109,278, filed Nov. 20, 1998.

### STATEMENT OF FEDERALLY SPONSORED RESEARCH/DEVELOPMENT

Not applicable.

### BACKGROUND OF THE INVENTION

This invention relates to the field of portable voice recorders and in particularly to lightweight, inexpensive dictation cards that can be secured to papers, files or other such business documents.

Virtually every field of business requires the interaction and cooperation of co-workers, partners and associates to perform tasks. There are times in which co-workers cannot be in direct communication with each other, such as when one colleague is undertaking another matter or out of the office. As such, information, instructions and questions may have to be communicated by leaving a message containing such information that the recipient will receive at a later time.

There are a number of well-known ways to provide a message for someone. For example, one can write the information on a piece of paper or notepad and deliver the message to the recipient's desk. Adhesive backed notepads can be used to attach notes to documents in an office environment. Preparing a note can be time consuming, however, and quickly prepared notes are often illegible. Further such notes require access to a writing implement and a writing surface which are not always available. Still another way to send a message is via electronic mail. However, this is only possible if the recipient has an email account, and the sender must know the account address and be at a computer terminal.

Still another means is to leave a verbal message. For example, one can communicate the information to an assistant of the intended recipient who will relay the message upon his or her return. Alternatively, one can leave a voice mail message via the telephone. This is a convenient and reliable method, however, it requires access to a telephone as well as a preexisting voice mail account. Still another way to leave verbal messages is by using a dictation machine.

Dictation machines are well known and typically consist of a recording apparatus that can be used to convert speech to electric signals suitably transferred to a storage medium, such as a magnetic tape. Initially, these machines were large desktop tape recorders. Technological advancements reduced their size allowing them to be held easily within one hand. The development of micro-cassette tape cartridges further reduced the size of the dictation machines. Such micro-cassette dictation cards are commonly used today by doctors and lawyers to dictate reports and memoranda for transcription by an assistant or secretary.

Digital dictation machines in which the speech is stored in a memory module, rather than a tape medium, are also well known. These digital devices are typically the same size as micro-cassette dictation device such that they are portable and can be hand-held. These devices eliminate the need for a tape, however, the amount of storage space is limited to the storage capacity of the memory module. Thus, when the memory is at full capacity, no additional dictation can be stored until the memory is cleared. Moreover, since the memory is permanently fixed on board the device, the entire device must be given to a transcriptionist, rather than merely one of many low cost cassette tapes. Additionally, because these devices are typically quite costly, one is unlikely to have a spare or backup device.

Some of these concerns are remedied by more sophisticated digital devices that can be interfaced with a computer to download the dictation and store it as a file on the computer. The file can then be sent electronically to a transcriptionist or processed by a speech-to-text engine. However, such sophisticates devices are costly and require access to a high-speed computer system. Further, none of the aforementioned dictation devices are particularly well suited for recording and distributing multiple, short-length notes.

Moreover, it is often desired to attach the message to a letter, file or other document. Common digital dictation devices are too large and heavy to attach to a paper or file. And, although it is true that tapes can be removed from their dictation machines and conveyed along with a document or file, they do not have a built-in attachment member for attaching the tape to the document or file. Moreover, common paper clips and adhesives are ineffective in properly securing the tape in place. Consequently, the tape may be lost or disassociated with a particular file or documents.

### BRIEF SUMMARY OF THE INVENTION

The present invention generally provides a system of communication, especially a system of improving work flow and communication between associates in a business environment.

Specifically, the present invention provides a communication system for conveying a spoken message from a speaker to a recipient. The speaker says the spoken message, which contains subject matter relevant to a particular matter. The message is recorded onto a portable dictation card having on-board digital record and playback capabilities. An attachment member of the dictation card is attached to a portable object associated with the relevant matter. The object is conveyed to the recipient who activates the dictation card to play back the message.

As mentioned, a preferred use of the present system in a business or office environment in which the recipient is a business or office associate and the message and object both pertain to a particular business matter or issue.

One purpose of this invention, therefore, is to increase productivity and communication in an office, home or industrial work environment. By relieving the message sender of the time consuming chore of putting his/her thoughts or message into writing his/her productivity has been enhanced.

The system is preferentially practiced with multiple essentially identical dictation cards, which are preferably stored in a cradle in an edge-wise orientation. The system can thus include providing the speaker with a plurality of digital dictation units of which the speaker selects one for recording a message.

The system can also include uncoupling the dictation card from the object and either retaining it, returning it to speaker or disposing of it. If the card is retained or returned, the system can also include clearing the message from the memory of the dictation card after playback so that the obsolete message is deleted and the card's memory is maximized for new messages.

Each card is preferably small, lightweight and low-cost, having a thickness of no more than 5 mm and weighing no more than 2 ounces. The attachment member of each card is preferably a paper receiving device, a clip, a magnet or an adhesive, such as a low-tack adhesive. Each card is portable and has an on-board battery powering digital record and playback circuitry, including record and playback control buttons, a microphone, an analog-to-digital converter, a processor, a memory module, and an output device, which can be an audio speaker or an electronic display panel, in which case the card also includes a speech to text system for converting the recorded message to a text message shown on the display.

Another purpose of this invention is to increase the accuracy of communication between parties. The message giver can leave a detailed explanation of his/her intentions with the attached papers or object, and not be limited to a small writing area of the typical sticky note. The exact message can be communicated along with voice inflections or in clear text.

Yet another purpose of this device is to make recorded voice communication inexpensive and common. It has the ability to change and simplify the way we do business and communicate. In addition it will greatly improve the accuracy of message content since the recipient is hearing the message in the sender's own words.

These and other objects, advantages and aspects of the invention will become apparent from the following description. In the description, reference is made to the accompanying drawings which form a part hereof, and in which there is shown a preferred embodiment of the invention. Such embodiment does not necessarily represent the full scope of the invention and reference is made therefore, to the claims herein for interpreting the scope of the invention.

### BRIEF DESCRIPTION OF THE SEVERAL VIEWS OF THE DRAWINGS

FIG. 1 is a front elevational view of a first embodiment of the thin profile digital dictation card of the present invention having an adhesive attachment member;

FIG. 2 is a side plan view of the dictation card of FIG. 1;

FIG. 3 is a back perspective view of the dictation card of FIG. 1;

FIG. 4 is a block diagram of the electronic circuitry of the dictation card of FIG. 1;

FIG. 5 is a simplified flow chart of a preferred communication system using the dictation card of FIG. 1;

FIG. 6 is a second embodiment of the dictation card of the present invention having a clip attachment member;

FIG. 7 is a third embodiment of the dictation card of the present invention having a magnet attachment member;

FIG. 8 is a fourth embodiment of the dictation card of the present invention in which it is integral with a file folder;

FIG. 9 is a fifth embodiment of the dictation card of the present invention having a solar panel, speech recognition engine and an electronic display;

FIG. 10 is an alternate embodiment of the dictation card of FIG. 9 having additional control capabilities; and

FIG. 11 is cradle for containing one or more dictation cards of the present invention.

### DETAILED DESCRIPTION OF THE INVENTION

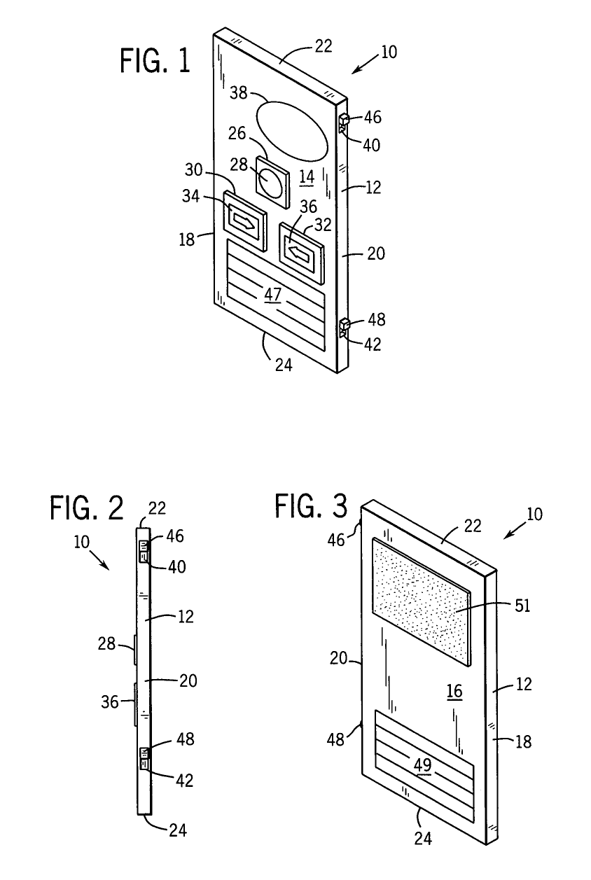

Referring to FIGS. 1-3, the dictation card of the present invention is referred to generally by the reference numeral 10. The dictation card 10 includes a preferably low-cost plastic housing 12 having a front 14, a back 16, sides 18 and 20 and top 22 and bottom 24 ends. The front 14 and back 16 of the housing 12 are broad, planar surfaces that are joined by the narrow sides 18, 20 and ends 22, 24 to define a small, thin-profile package approximately the size of a standard business card. The housing front 14 has an opening 26 for receiving a thin-profile record button 28 and two additional openings 30, 32 for receiving a similar playback button 34 and a reverse cue button 36, respectively. The housing front 14 also defines a loudspeaker/microphone opening 38 through which sound may pass. Other less accessible controls are located at the right side 20 which has two openings 40 and 42 near respective top 22 and bottom 24 ends in which are disposed a record lock 44 and a message clear button 46, respectively. The controls are simple and intuitive enough for anyone to use immediately. Disposed in a suitable location on the front 14 and back 16 of the housing 12 are labels 47, 49 having lines for writing information such as the content of the stored message(s) or the identification of the speaker.

Preferably, the housing is no larger than 100 mm×70 mm×5 mm and the dictation card weighs no more than 2 ounces. Its small size and low weight allow the dictation card to be easily handled and passed along from a speaker to a message recipient. Its thin profile also allows one or more cards to be stacked together in a small space for storage or stacked on top of or in between documents and files. Additionally, on the back 16 is an attachment member 51 for securing the dictation card to a stationary or portable object. In a first embodiment shown in FIGS. 1-3, the attachment member 51 is an adhesive. The adhesive is preferably low-grip allowing the dictation card 10 to be adhered and easily removed from a business object or document such as a file, computer screen, telephone or any other such object multiple times. The dictation card 10 may be attached to objects in other ways, as described below with regard to alternate embodiments of the invention.

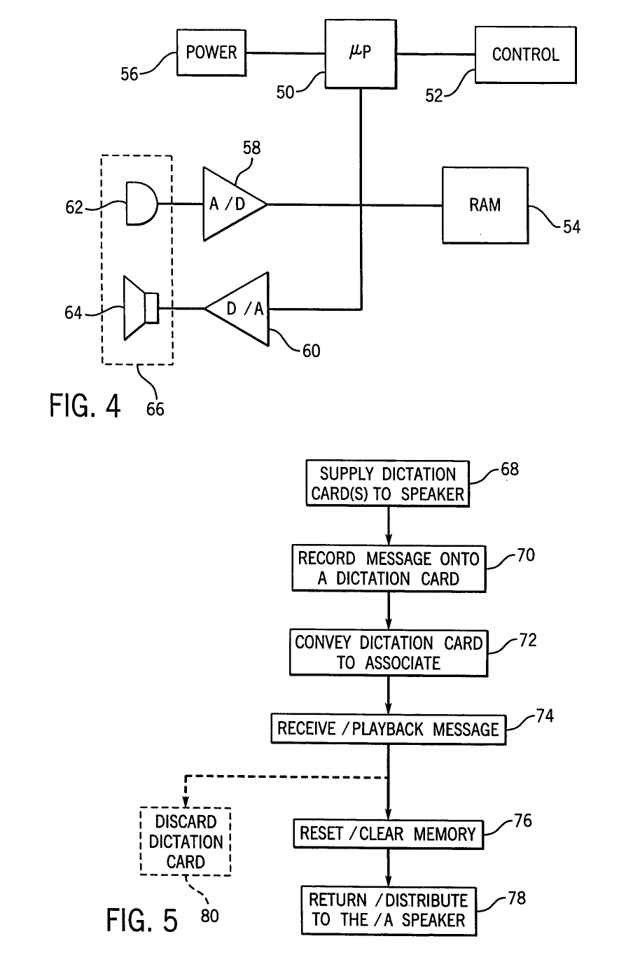

The housing 12 contains record/playback circuitry the construction of which may be in accordance with the teachings of U.S. Pat. No. 4,791,741 entitled: Card With Built-In Record/Playback Capabilities hereby incorporated by reference. Referring to FIG. 4, generally, the record/playback circuitry 48 includes a processor 50 electrically connected to an input controller 52, a read/write memory module 54, a power supply 56, an analog-to-digital (A/D) converter 58 and a digital-to-analog (D/A) converter 60. These elements may be separate components, or with the exception of the power supply 56, they may be included in a single microcontroller chip, as is known in the art. In either case, the elements may be any suitable standard electronic components known in the art.

The A/D converter 58 is electrically connected to a suitable microphone 62 and the D/A converter 60 is electrically connected to a suitable loudspeaker 64. It should be noted that the figure shows the microphone 62 and loudspeaker 64 as separate components, however, the invention is not limited in this regard as a single piezoelectric device 66 may be used instead. Preferably, the memory module 54 has sufficient capacity to store up to 5 minutes of monaural audio signals. The dictation card 10 of the present invention is not limited in this regard, however, as memory modules having more or less capacity can be used depending upon the intended use of the cards.

The dictation card 10 is operated by a speaker depressing the record button 28 while speaking a message. The record button 28 may be depressed and held throughout the duration of the message or once at the beginning and end of the message. As the speaker begins uttering a message, the microphone 62 converts the audio waves into analog electronic signals. These analog signals are converted into a digital representation by the A/D converter 58. The processor 50 begins processing these signals upon receipt of a record input signal sent from the controller 52 initiated by depressing the record button 28. The digital signals are then stored in the memory module 54 for playback. Additional recording may be added on to full capacity of the memory 54 at any time. Moreover, the processor 50 can be programmed to augment an original message with additional recording, thus, treating the stored signals as one message. Alternatively, the processor 50 can index and store the signals as a new message each time the record button 28 is depressed.

The speaker or message recipient may then depress the playback button 34 which initiates a playback signal from the controller 52 to the processor 50. The processor 50 then begins transmitting the stored message from the memory module 54 to the to the D/A converter 60, which converts the digital message signal to analog format to be output via the loudspeaker 64. Preferably, the processor 50 will default to playing stored messages from the beginning upon receiving a playback signal. In this way, the speaker can quickly playback the message to review its contents or ensure that it was properly recorded. Also, the message recipient can playback and replay the message multiple times by depressing the playback button 34 once time each. Alternatively, the user could “rewind” the message using the reverse cue button 36. In either case, the user can quickly repeat a part or all of stored message by depressing and holding the reverse cue button 36, which initiates a rewind signal from the controller 52 to the processor 50.

Because of its low cost, the dictation card 10 may be designed to be disposable after one or a fixed number of uses, for example 25 messages. For disposable dictation cards 10 the power supply 56 is preferably a low voltage, direct current battery, such as a mercury filled battery. If the dictation card 10 is to be reused indefinitely, the housing 12 includes a battery compartment cover (not shown) that may be removed so as to replace an expired battery. Alternatively, the power supply 56 may be a nickel-cadmium or other such rechargeable battery. In this case, the dictation card 10 includes a standard input jack (not shown) coupled to the power supply 56 for connecting an electrical charging card (not shown). The dictation card 10 would also include an indicator light (not shown) at the front 14 that illuminates during charging. As yet another alternative, the power supply 56 may be a small solar panel such as that commonly used in small electronics such as calculators.

The dictation card 10 of the present invention may used to convey messages at home, an office or an industrial facility, such as a hospital or restaurant. For example, the diction card 10 may be used to convey brief messages in an office setting such as instructions for a secretary or telephone messages taken while the intended recipient was away. It may be used for brief messages in other settings such as by a nurse to convey a patient's status to a doctor, or by parents for leaving instructions about after school activities. The dictation card may also be used to record longer dictation to be transcribed by a human or electronic transcriptionist.

Referring to FIG. 5, a preferred method of use includes supplying one or more dictation cards 10 to a speaker, as shown in block 68. Since the dictation cards 10 are low cost and small, the speaker can affordably store a plurality of cards 10 for example at his/her desk without occupying a significant amount of desk space. At block 70, the speaker can select one of the dictation cards 10 and record a message by depressing the record button 28 and speaking, as described above. The dictation card 10 having the message is then conveyed to an associate or any other intended message recipient, at block 72. This can be done transporting the dictation card 10 alone or, however, preferably the dictation card 10 is physically attached to a portable business object, document or file to which the content of the message on the dictation card pertains. At block 74, once the dictation card 10 is received by the associate, the message is played by depressing the playback button 34. After the message has been conveyed, at block 76, the memory 54 can be erased or reset by depressing the message clear button 46 and the dictation card 10 returned to the original speaker or any other message sender, at block 78. Alternatively, because of its low cost, after the message has been played the dictation card 10 can be discarded, at block 80.

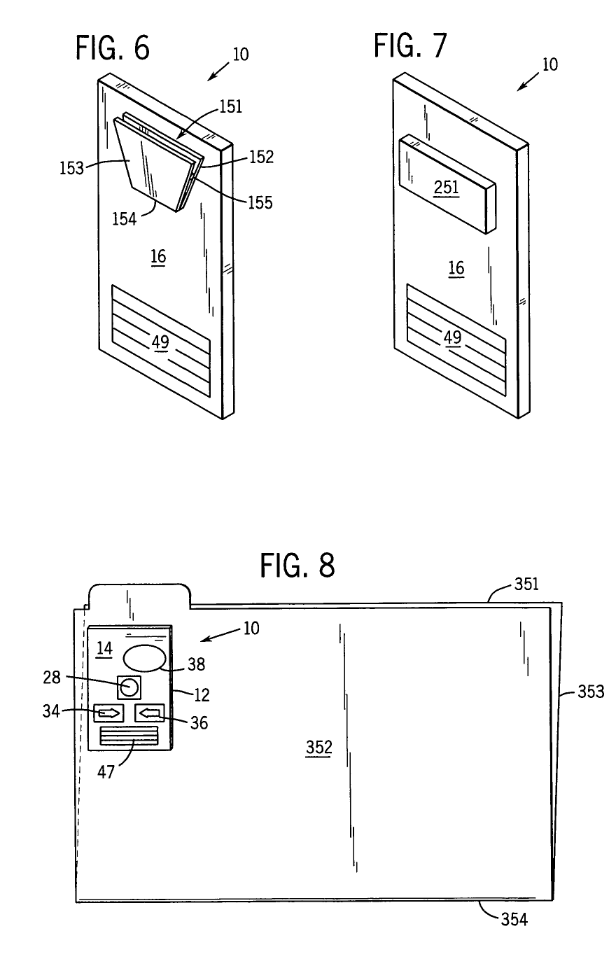

Referring to FIG. 6, the dictation card 10 is identical to that of the first embodiment, however, the attachment member 151 is a spring biased clip having opposing clasp members 152 and 153 biased together along a bottom edge 154 by a spring 155. This attachment member provides a positive connection of the dictation card 10 to files, letters and other business documents. Alternatively, referring to FIG. 7, in a third embodiment of the present invention, the dictation card 10 is identical to that of the first embodiment expect that the attachment member 251 is a magnet. The magnet is suitably attached to the housing back 16, such as by an adhesive. This attachment member 251 allows the dictation card 10 to be affixed to any metal object, such as those commonly found in an office environment including a file cabinet, file organizers, book ends, staplers. Similarly, the dictation card 10 of this embodiment could also be conveniently used at home to leave a message for a family member by attaching the dictation card 10 to a refrigerator, as is commonly with paper notes. Moreover, this dictation card 10 could be used in industries, and be affixed to metal objects in a machine shop or a restaurant, for example. A magnetic attachment member can be used with the dictation card 10 of the present invention without erasing a stored message as may occur in conventional tape-based dictation devices.

Still further, as shown in FIG. 8, a fourth embodiment of the present invention the dictation card 10 is identical to that of the first embodiment expect that it includes a paper receiving member 351 as the attachment member. The paper receiving member 351 has two plastic planar halves 352 and 353 joined along a bottom edge 354. In this embodiment, the dictation card 10 is integrally joined to the paper receiving member 351 at the back 16 by any suitable means such as an adhesive or a heat or ultrasonic welding process. The paper receiving member 351 could be any common office type paper folder including an accordion or clasp envelope. Preferably, the paper receiving member 351 is sized to contain a standard letter sized paper, however, it can be any suitable size including that necessary for containing standard legal and internal papers.

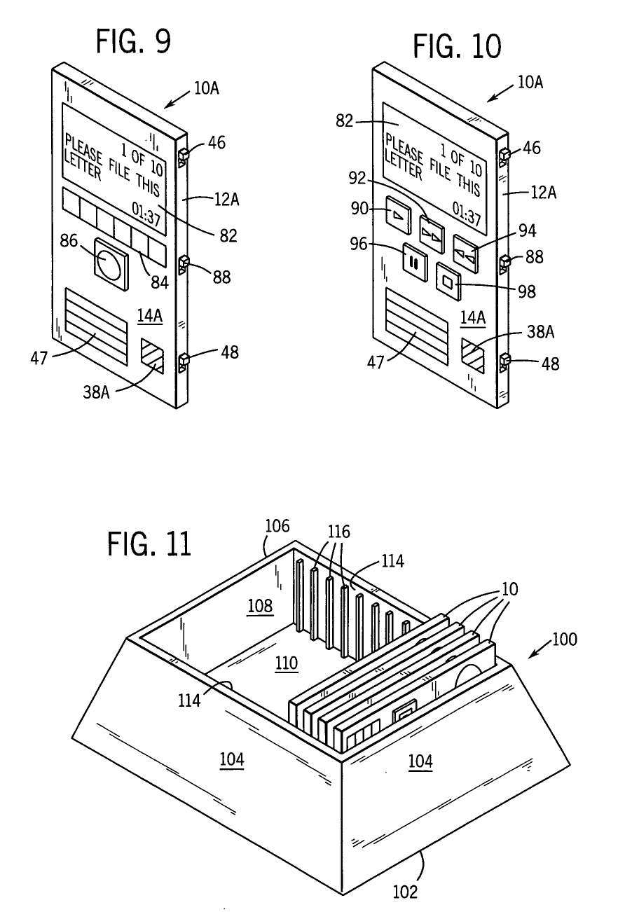

Referring to FIG. 9, in a fifth embodiment of the present invention, the dictation card 10A has a thin profile housing 12A having substantially the same dimensions as housing 12. The housing 12A, however, the front 14A includes openings for receiving a display 82 for viewing message text, a solar panel 84 for energizing the card, and a single multi-function button 86. In addition, the loudspeaker/microphone opening 38A is smaller and in a different location than that of the first embodiment. The front 14A also includes a label 47. The right side 20 includes openings for record lockout 44 and message clear 46 switches as described above as well as a mute switch 88 for suppressing audio playback of the messages. The record/playback circuitry (not shown) is identical to that of the first embodiment, however, the memory module stores a speech recognition grammar set, as known in the art, which the processor uses to model the digitized audio signals received from the microphone so as to convert the spoken message to text, which the processor sends to the display 82, in addition to or instead of the loudspeaker, depending upon the position of the mute switch 88. Lengthier messages are presented by the message text on the display. The processor and display also operate to indicate the total number and time of stored messages as well as the number and time of the current message. Additionally, the multi-function button 86 is used to record and playback messages as well as scan an index of stored multiple messages.

Referring to FIG. 10, a sixth embodiment of the present invention is identical to the fifth embodiment, except that the power supply is a battery and the single multi-function button is replaced by standard cassette controls, including a playback button 90, a fast cue button 92, a reverse cue button 94, a playback pause button 96 and a stop button 98.

Referring to FIG. 11, a plurality of dictation cards 10, of any of the above described embodiments, may be stored in a cradle 100 when not being used. The cradle 100 has a base 102 and four exterior sides 104 tapering inwardly from the base 102 to a top perimeter 106. Four interior sides 108 extend vertically from a floor 110 to the top perimeter 106. Two opposing interior sides 112 and 114 include partitioning ribs 116 spaced throughout each side 112 and 114 to define slots for receiving a dictation card 10.

For rechargeable dictation cards 10, the cradle 100 can include positive and negative conductive terminals (not shown) at one or both of sides 112 and 114 so as to contact positive and negative terminals (not shown) at one or both of the top 22 and bottom 24 ends of a dictation card 10. The cradle terminals are electrically coupled to a DC transformer (not shown) via a conductive lead (not shown). The dictation card terminals are suitably coupled to the terminals of the rechargeable battery. The cradle can include positive and negative terminals for each slot defined by the partition ribs 116 so that a dictation card 10 can be recharged in any slot and so that multiple cards can be recharged at the same time. Alternatively, terminals can be provided in only one recharging slot, such as the first slot. The cradle 100 also includes an indicator light (not shown) which illuminates when a dictation card is being charged.

The present invention may include other aspects not specifically delineated in the aforementioned preferred embodiments. The above in no way is intended to limit the scope of the invention. Accordingly, in order to apprise the public of the full scope of the present invention, reference must be made to the following claims.

I claim:

1. A communication system for conveying a spoken message from a speaker to a recipient, comprising:
said speaker saying said spoken message in which said spoken message contains subject matter relevant to a particular matter;
recording said message onto a portable dictation card having digital record and playback capabilities and an attachment member;
coupling said attachment member of said dictation card to a portable object associated with said matter;
conveying said object to said recipient; and
said recipient activating said dictation card to play back said message.

2. The system of claim 1, further comprising selecting said dictation card from a plurality of essentially identical dictation cards.

3. The system of claim 2, wherein said plurality of dictation cards are stored in a cradle which defines an opening partitioned to retain each of said plurality of dictation cards individually in an edge-wise orientation.

4. The system of claim 1, further comprising clearing said spoken message from said dictation card after the said message was played back to said recipient.

5. The system of claim 1, further comprising uncoupling said dictation card from said object.

6. The system of claim 5, further comprising returning said dictation card to said speaker.

7. The system of claim 5, further comprising disposing of said dictation card.

8. The system of claim 1, wherein said attachment member is selected from the group of attachments consisting of a paper receiving device, a clip, a magnet and an adhesive.

9. The system of claim 1, wherein said dictation card includes a record button and a playback button, said record button being depressed by said speaker when recording said spoken message and said playback button being depressed by said recipient when playing said spoken message.

10. The system of claim 1, wherein said dictation card includes:
a battery;
a microphone for receiving audio signals corresponding to said spoken message;
an analog to digital converter for digitizing said audio signals;
a processor for receiving input signals from said controller and processing said input signals and said digitized audio signals;
a memory module linked to said processor for storing said digitized audio signals upon said processor receiving a record input signal from a controller; and
an output device linked to said processor for presenting said stored digitized audio signals upon said processor receiving a playback input signal from said controller.

11. The system of claim 1, wherein said dictation card is no thicker than 5 mm.

12. The system of claim 1, wherein said dictation card weighs no more than 2 ounces.

13. The system of claim 1, wherein said message is played back to said recipient audibly.

14. The system of claim 1, wherein said message is played back to said recipient visually via an electronic display panel on the dictation card.

15. The system of claim 14, wherein said dictation card further includes a speech to text system for converting said recorded message to a text message shown on said display.

16. An office work flow and communication system for conveying a spoken message from a speaker to an office associate, comprising:
providing said speaker with a plurality of digital dictation units, said dictation units being essentially identical each with record and playback functions and an attachment member;
selecting one of said dictation units;
said speaker activating said record function of said selected dictation unit;
said speaker saying said spoken message in which said spoken message contains subject matter relevant to a business matter;
said selected dictation card recording said message;
coupling said selected dictation card to an office object associated with said business matter via said attachment member;
conveying said office object to said office associate; and
said office associate activating said playback function of said selected dictation card to play back said message.

17. The system of claim 16, wherein said plurality of dictation cards are stored in a cradle which defines an opening partitioned to retain each of said plurality of dictation cards individually in an edge-wise orientation.

18. The system of claim 16, further comprising said office associate uncoupling said selected dictation card from said office object.

19. The system of claim 18, further comprising returning said selected dictation card to said speaker.

20. The system of claim 18, further comprising disposing of said selected dictation card.
